(19) United States
(12) Patent Application Publication
(10) Pub. No.: US 2004/0021636 A1
(43) Pub. Date: Feb. 5, 2004

(54) Computer-type peripherals

(76) Inventors: Stuart Bruce Venn, Palmwoods (AU); Judith Venn, Palmwoods (AU)

Correspondence Address: Laura G Barrow, PO Box 215, Estero, FL, 33928, US

(21) Appl. No.: 10/381,627

(22) PCT Filed: Sep. 26, 2001
(86) PCT No.: PCT/AU01/01209

(30) Foreign Application Priority Data
Sep. 27, 2000 (AU) PR 0378
Mar. 22, 2001 (AU) 28152/01

(51) Int. Cl. G09G 5/08

(52) U.S. Cl. 345/163

(57) ABSTRACT

A peripheral device—a mouse assembly—is disclosed which can be used to communicate with the processing capabilities of a computer to first establish that the user of that device is an authenticated user prior to allowing access to computer resources. The mouse incorporates left and right controlling buttons. The underside of the mouse incorporates a trackball and a recessed numeric keypad. Movement of the buttons and trackball are communicated to a computer via a first communication link connected to a first port of the computer. Security data is read from a data-containing medium and communicated to the computer via a second communication link connected to a second port of the computer. On initial power-up of the computer, the operation of the buttons and trackball are disabled. After the security data is used to grant access to the computer, the mouse buttons and trackball are enabled.

THIS INVENTION relates to peripherals for computers, work stations and similar. In particular, although in no way limiting, it is directed to a peripheral device which, when required, can be used to communicate with the processing capabilities of a computer to first establish that the current user of that device is an authenticated user prior to allowing access to computer resources. Such a capability of the present invention finds especial use when, inter alia, undertaking a financial transaction to enable a purchase of goods or services over a telecommunication medium, or whereby authentication of a user is required prior to undertaking any secure transaction. However, it will be appreciated that the invention is equally applicable to any transaction that requires reading and/or transmission of data stored on a machine-readable device.

The advertising of goods and services over media such as television and the Internet is now commonplace.

With television advertising, the public can often purchase the goods or services so-advertised over the telephone quoting details of a credit or debit card. Typically, the vendor draws the full payment from the bank account linked to the credit or debit card and then forwards the goods to the purchaser.

With the Internet now well known as an electronic medium and powerful communications tool the seamless system (World Wide Web) linking information on different computers, the general public can readily access the Internet for a wide variety of purposes, including to order numerous consumer goods and/or services online. Once again, payment for these goods and/or services is often by quoting details of a credit or debit card.

To engage in such a purchase, it is not necessary to be in physical possession of the credit or debit card. Before a sale is authorised over a telecommunication medium, all that is usually required is to cite the account number, name of the card holder and possibly a special code specific for that account (the so called Personal Identification Number (PIN). However, as PIN and account numbers are not dependent on any cross checking to ensure that the are being quoted over the telecommunication medium by the true proprietor of that PIN number and its associated credit card or bank account, this type of transaction is not too difficult to circumvent. Accordingly, people remain wary of undertaking such purchases, particularly over the Internet, for fear that their credit details will be downloaded by unauthorised parties who will then use those details fraudulently.

Similar security problems exist for business-to-business e-commerce, electronic ticketing and other activities which are now being promoted by the computer and Internet-based industries.

This disadvantage is partially reduced by payment of goods at their point of sale (EFTPOS)) as the purchaser must at least be in physical possession of the card. Further security can be offered by using a smart card whereby, for example, certain biometric data of the proprietor of the card is encoded on the card thus providing, if required, the mechanism for an additional verification that the purchaser is entitled to undertake that transaction with that card. However, for purchases at locations away from commercial centres, such as for home-based shopping online, these EFTPOS-type facilities are generally not available.

Even if a dedicated EFTPOS-type terminal could be supplied at an affordable cost for home-based online purchasers, the frequency of such transactions is still too low for the average person with a home computer to justify the purchase of such a dedicated terminal.

Nevertheless, there have been prior art devices which appear to overcome the above disadvantages of home-based shopping online.

For example, one possible solution to this disadvantage is disclosed in U.S. Pat. No. 5,550,561 which describes a cursor pointing device, typically a mouse, integrated with a card reader assembly. The appropriate financial data is first read from the card and the cursor device then transfers this data over a telecommunication medium to facilitate a purchase of goods or services.

However, this cursor pointing device appears to be dedicated solely to the entry of monetary information for a financial transaction to occur over a telecommunication medium and the user of such a device would thus have to switch to a conventional cursor pointing device for other operations of the computer. Having two distinct cursor pointing devices to be swapped periodically depending on the task to be performed is, at least, inconvenient and fails to resolve at least one of the afore-mentioned disadvantages, namely, that a separate dedicated device has still to be purchased for such financial transactions to be undertaken.

A second possible prior art solution is the mouse system which incorporates a smart card reader as described in U.S. Pat. No. 6,055,592. A mouse is integrated with a card reader connected to a computer via an existing interface port on the computer. This system is not limited to the transfer of financial data as, essentially, a converter in the mouse system determines when to transmit card data and when to transmit cursor position information. Thus, a single mouse can be used, in contrast to U.S. Pat. No. 5,550,561 discussed above where two mice would be required. Further, U.S. Pat. No. 6,055,592 envisages a procedure for granting access to a user of a computer system whereby access is granted to the user when the user is identified as an authorised user (from the information read from the card) and would deny access when the user fails to be identified as an authorised user of the system.

However, one major disadvantage of the system of U.S. Pat. No. 6,055,592 is that, because it operates through the existing interface port of a computer, a change in the known mouse drivers would be required, even if the mouse system was only to be used for the conventional pointing operations separate from any reading of data from a magnetic strip or smart card or similar data-carrying medium.

Yet another possible prior art solution is disclosed in PCT/FR97/00991 whereby an electronic device is interposed between the keyboard and the CPU, the device verifying the authorisation access of the user and subsequently allowing or disallowing access to the CPU dependent on the authorisation outcome. However, once again, the disadvantage remains of using the existing interface port of the computer.

Further, these prior art systems only check any authentication data once. After authentication has been approved, the approved operation can continue until the user physically terminates the operation. Therefore, once initial access has been gained, perhaps fraudulently, there is the opportunity for fraudulent activities to continue unabated.

There thus remains a need for a cursor controlling device which can function as a pointing device compatible with existing drivers, but which is capable of independently reading data from a data-carrying medium and initiating certain actions based on the information thus-read, and which could periodically establish that the continued use of facilities thus accessed by the pointing device is authenticated.

Therefore, according to the present invention, there is provided a cursor control assembly for controlling the grant of access to the facilities of an electronic data processing unit, said control assembly including:

a first communication means between said cursor control assembly and a first interface port of said electronic data processing unit, said first communication means adapted to grant access to one or more facilities of said electronic data processing unit;

a reader assembly capable of reading a data-containing medium;

a second communication means between said reader assembly and a second interface port of said electronic data processing unit, said second communication means adapted to pass data read from said data-containing medium to said electronic data processing unit;

whereby, said cursor control assembly and said electronic data processing unit are adapted such that, when required by a user-of said electronic data processing unit, said reader assembly first reads said data-containing medium to determine whether said first communication means should grant said access to said facilities of said electronic data processing unit.

Preferably, said cursor control assembly is selected from a keyboard or a pointing device.

More preferably, said cursor control assembly is a pointing device.

Preferably, said pointing device is a pen, glidepad, trackball or mouse assembly.

More preferably, said pointing device is a mouse assembly.

Preferably, said data-containing medium is selected from a credit, debit or smart card, or other information carrying medium such as the iButton®.

As a first option, said cursor control assembly further includes a check means adapted to check that any currently authenticated user of said assembly is still operating said assembly.

As a second option, said cursor control assembly further includes a key pad, said key pad including numeric and other keys required to facilitate a financial or other transaction.

As a third option, said cursor control assembly further includes verification means whereby verification data is obtained from the person attempting to use said cursor control assembly and then compared against similar verification data held on said data-containing medium; and if the two sets of verification data match, verification of the authenticated user is deemed positive.

Preferably, said verification data is biometric data.

A preferred embodiment will now be described with reference to the accompanying drawings wherein:

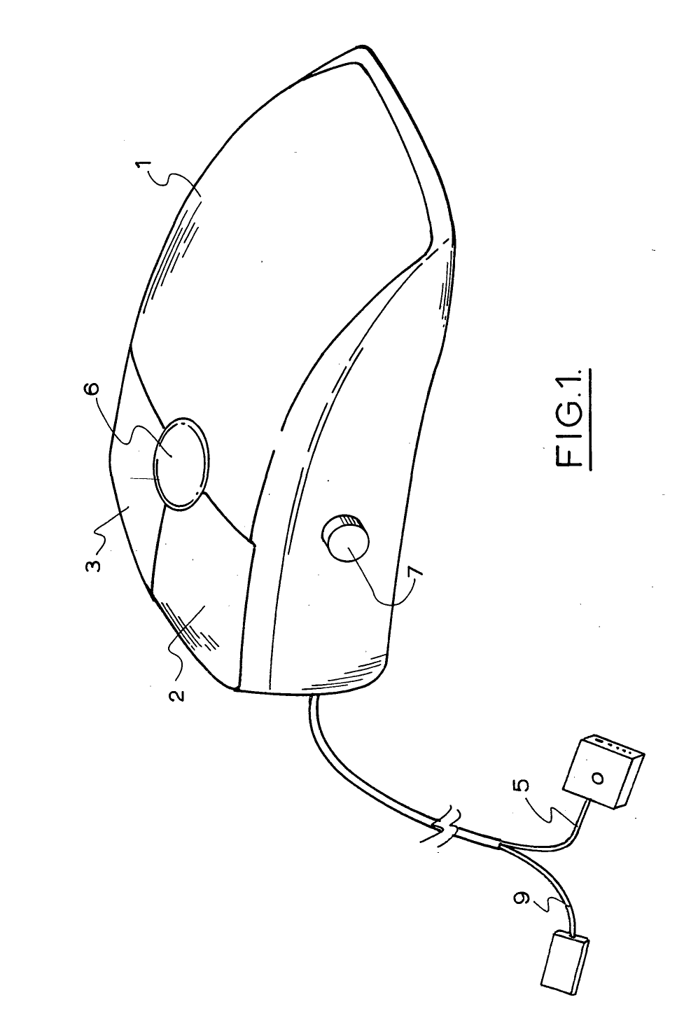

FIG. 1 is a top schematic perspective view of a cursor control assembly, in the form of a mouse, which is constructed in accordance with the present invention; and

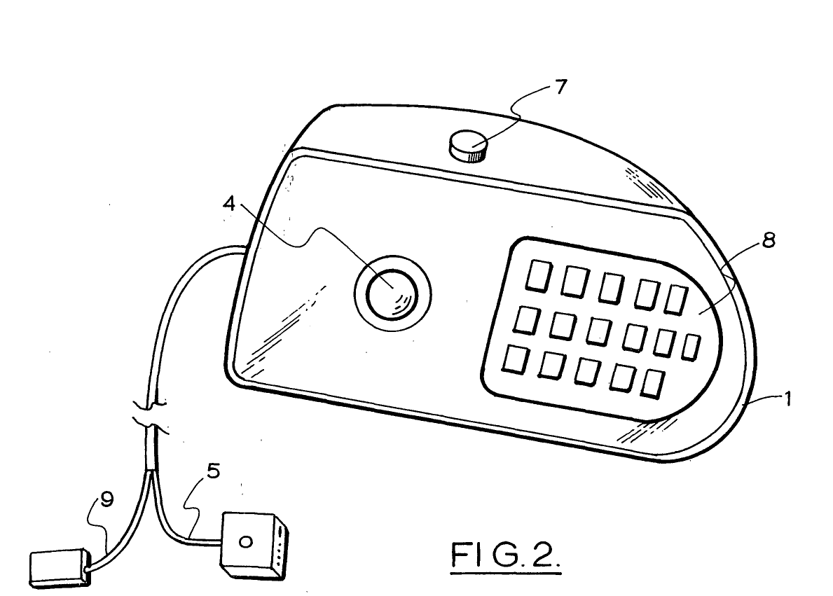

FIG. 2 is a bottom schematic perspective view of the mouse of FIG. 1.

Referring to the figures, the upper body of the mouse (1) incorporates left (2) and right (3) controlling buttons. The underside of the mouse (1) incorporates a trackball (4). The buttons (2,3) and trackball (4) are all well known features in the art for the conventional operation of the mouse (1), movement being communicated to a computer via a first communication link (5) connected to a first port (not illustrated) of the computer. A Blue Dot Receptor™ (6) for an iButton®, as manufactured by Dallas Semiconductor Corporation, is incorporated into the upper body of the mouse (1) between the two buttons (2,3). On one side of the mouse (1) is a third button (7). This button (7) is spring-biassed between two positions, to open and close an electrical circuit. Recessed into the underside of the mouse (1) is a numeric keypad (8). The Blue Dot Receptor™/iButton® (6), third button (7) and keypad (8) are adapted by any suitable means known in the art so that their activation can be communicated via a second communication link (9) connected to a second port (not-illustrated) of the computer. A rechargeable battery (not illustrated) may be incorporated into the appropriate circuitry to ensure adequate power is always available for the continued operation of the cursor control assembly.

In use, the computer is powered up. Power is simultaneously applied to the first mouse port connected to the link (5) and to the second port connected to the link (9). On this initial power-up, the operation of the buttons (2,3) and trackball (4) are disabled. The computer then seeks data from an iButton®, the iButton® containing the necessary authentication data for the functions of the computer to be accessed. The authentication data can be any combination of username, password, biometric data, etc, as is well known in the art. The data thus read by the Blue Dot Receptor™ (6) is communicated to the computer seeking that data. If authentication data is not present, or if invalid data is read, the operation of the buttons (2,3) and trackball (4) remain disabled. If valid data is obtained from the iButton®, all functions of the computer for which the user is authorised to access are enabled. The computer constantly monitors for the presence of the Blue Dot Receptor™ (6) and/or an iButton®. If the Blue Dot Receptor™ is removed or is not otherwise functioning, or if a valid iButton® is not present, a signal is communicated to the computer which disables all functions. Periodically, the computer sends a request to operate the third button (7). If that third button (7) is not operated within a specified period, it is concluded that an authenticated user is no longer present and all functions of the computer are disabled.

Once an authenticated user is logged on to the computer, other operations can be effected, for example, connection to the Internet. The usual password and other verification data necessary to access the Internet can be stored on an iButton®, as can the sequential keystrokes necessary to activate access to the Internet. Preferably, the software employed to access the Internet also establishes an electronic firewall preventing access to the local computer's hard drive by any other undesired remote computer-system and the logon to the Internet can be made directly through the communication link (9), any keystroke entries necessary being undertaken from either the keypad (8) on the mouse (1) or from any sequential keystrokes deployed by reading of the iButton®, thus eliminating the need for any such information to be stored on the hard drive of the computer. Once again, if the Blue Dot Receptor™ (6) is removed or is not otherwise functioning, or if a valid iButton® is not present, or if the button (7) is not pressed within the specified period when requested, disconnection from the Internet occurs. Modifications to this software include the incorporation of an on-screen display of the available time purchased for access to the Internet. Once the available time has been exhausted, automatic disconnection to the Internet occurs. Yet another modification is the linking of the button (7) and an iButton® such that, on pressing the button (7), a pop-up menu appears which identifies the functions which are available to the particular authenticated user.

It will be appreciated that, as an alternative to the Blue Dot Receptor™/iButton® technology, any suitable credit, debit or smart card, with data on that card being encrypted or not, can be used with the present invention.

Irrespective of the data-carrying medium used, any suitable encryption technology known in the art can be used first to encrypt any un-encrypted data thus read from the medium before sending same to a remote location over a telecommunication medium, thus improving security of the transmitted data.

Further, the assembly can be hard wired to the computer or controlled remotely using, as an example, known infra red technology; or the assembly can be a combination of hard wired or remote control. Also, communication of the thus read data can be undertaken by wire or wireless transmissions. Finally, the present invention can be incorporated into desktop, laptop or palmtop computers, or into WAP-enabled devices.

The present invention thus provides a mechanism for a more secure operation of a computer.

A typical use for the present invention is for EFTPOS-type purchases to be undertaken remote from the more traditional commercial centres while still requiring the purchaser to be in physical possession of the credit, debit or smart card or other data-carrying medium, thus maintaining a level of security for the financial and other data that is necessarily transmitted over a telecommunication network for such purchases. In particular, it obviates the need to store such data on the hard drive of a computer and to transmit that data using the keyboard of that computer.

However, other uses are to be encompassed within its scope whenever some form of “verification” is required before the computer will function as requested, whether that be to initiate transfer of data over a telecommunication medium or to issue hard-copy information from the computer, etc.

It will also be appreciated by those skilled in the art that, although specific reference has been made to incorporate a reader assembly into a mouse, the reader assembly could also be incorporated into other peripherals such as the keyboard and visual display unit, or even into the casing of a computer.

Of course, other modifications and alterations could be made without departing-from the inventive concept as defined in the following claims.

1. A cursor control assembly for controlling the grant of access to the facilities of an electronic data processing unit, said control assembly including:
a first communication means between said cursor control assembly and a first interface port of said electronic data processing unit, said first communication means adapted to grant access to one or more facilities of said electronic data processing unit;
a reader assembly capable of reading a data-containing medium;
a second communication means between said reader assembly and a second interface port of said electronic data processing unit, said second communication means adapted to pass data read from said data-containing medium to said electronic data processing unit;
whereby, said cursor control assembly and said electronic data processing unit are adapted such that, when required by a user of said electronic data processing unit, said reader assembly first reads said data-containing medium to determine whether said first communication means should grant said access to said facilities of said electronic data processing unit.

2. A cursor control assembly as defined in claim 1, wherein said cursor control assembly is selected from a keyboard or a pointing device.

3. A cursor control assembly as defined in claim 2, wherein said cursor control assembly is a pointing device.

4. A cursor control assembly as defined in claim 3, wherein said pointing device is a pen, glidepad, trackball or mouse assembly.

5. A cursor control assembly as defined in claim 4, wherein said pointing device is a mouse assembly.

6. A cursor control assembly as defined in any one of claims 1 to 5, wherein said data-containing medium is selected from a credit, debit or smart card, or an iButton®.

7. A cursor control assembly as defined in any one of claims 1 to 6, wherein said cursor control assembly further includes a check means adapted to check that any currently authenticated user of said assembly is still operating said assembly.

8. A cursor control assembly as defined in any one of claims 1 to 7, wherein, said cursor control assembly further includes a key pad, said key pad including numeric and other keys required to facilitate a financial or other transaction.

9. A cursor control assembly as defined in any one of claims 1 to 8, wherein said cursor control assembly further includes verification means whereby verification data is obtained from a person attempting to use said cursor-control assembly and then compared against similar verification data held on said data-containing medium.

10. A cursor control assembly as defined in claim 9, wherein said verification data is biometric data.
